(19) United States
(12) Patent Application Publication
(10) Pub. No.: US 2006/0002404 A1
(43) Pub. Date: Jan. 5, 2006

(54) Data transmission control apparatus and data transmission control method

(76) Inventor: Norihiko Igarashi, Ome-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/082,718

(22) Filed: Mar. 17, 2005

(30) Foreign Application Priority Data
Jun. 30, 2004 (JP) 2004-193765

(51) Int. Cl. H04L 12/28

(52) U.S. Cl. 370/401

(57) ABSTRACT

A data transmission control apparatus controls data transmission between a first wireless network and a second wireless network. According to one embodiment, the data transmission control apparatus comprises a wireless communication device that uses an identifier for identifying a wireless network as an access object and a device driver to control the wireless communication device. The device driver switches the identifier, which is used by the wireless communication device, between a first identifier for identifying the first wireless network and a second identifier for identifying the second wireless network.

### CROSS-REFERENCE TO RELATED APPLICATIONS

This application is based upon and claims the benefit of priority from the prior Japanese Patent Application No. 2004-193765, filed Jun. 30, 2004, the entire contents of which are incorporated herein by reference.

### BACKGROUND

1. Field

Embodiments of the present invention relate to a data transmission control apparatus and a data transmission control method, which control data transmission between two networks.

2. Description of the Related Art

A firewall is generally known as a security system for preventing an attack on an internal network from an external network such as the Internet. For example, Jpn. Pat. Appln. KOKAI Publication No. 2001-325164 discloses a communication system that includes a firewall apparatus.

The firewall is a function for preventing a packet, which causes a security problem, from being transmitted from an external network to an internal network. In usual cases, the firewall is realized using a data transmission control apparatus that connects two networks. However, the data transmission control apparatus needs to be equipped with two network interface cards that correspond to the two networks. This is a main factor that causes an increase in cost of the data transmission control apparatus.

The data transmission control apparatus can also be realized using a personal computer in which firewall software is installed. However, in this case, too, the personal computer needs to be equipped with two network interface cards.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exemplary block diagram that shows the structure of a communication system using a data transmission control apparatus according to an embodiment of the present invention;

FIG. 2 illustrates an exemplary packet transmission operation that is executed by the data transmission control apparatus shown in FIG. 1;

FIG. 3 is an exemplary block diagram that shows a functional configuration of the data transmission control apparatus shown in FIG. 1;

FIG. 4 illustrates a scheme in which a wireless LAN card, which is provided in the data transmission control apparatus shown in FIG. 1, is recognized as two devices by an application program; and

FIG. 5 is a view for explaining functional configurations of a device driver and a firewall program that are provided in the data transmission control apparatus shown in FIG. 1.

### DETAILED DESCRIPTION

Embodiment of the present invention will now be described with reference to the accompanying drawings.

In the following description, certain terminology is used to describe features of the present invention. For example, “wireless node” is an electronic device with wireless communication capabilities. A “software module” is executable code such as an operating system, a program, or even a routine for example. The module may be stored in any appropriate storage medium such as a hard disk drive, a CD-ROM, semiconductor memory (non-volatile or volatile), tape, etc.

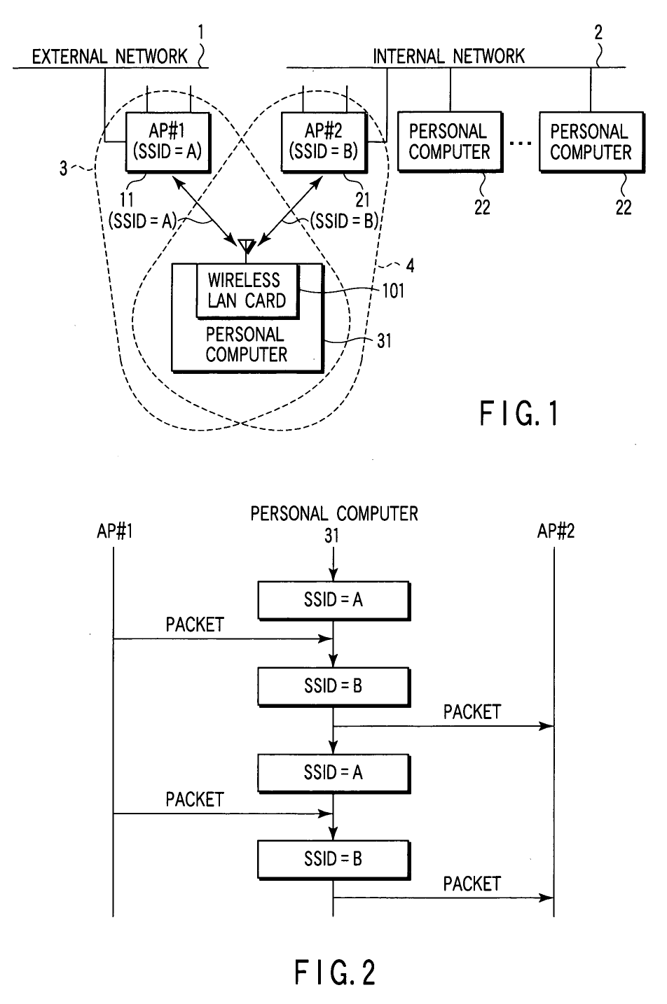

FIG. 1 shows an exemplary structure of a communication system using a data transmission control apparatus 31 according to an embodiment of the present invention. The data transmission control apparatus 31 according to the present embodiment is realized as a personal computer 31 that is equipped with a single wireless communication device (e.g., wireless LAN card) 101. It is contemplated, however, that the data transmission control apparatus 31 may be implemented as a variety of electronic devices in lieu of a personal computer (e.g., desktop, notebook, handheld, etc.). Examples of various types of electronic devices include, but are not limited or restricted to a personal digital assistant (PDA), a mobile telephone or the like.

The personal computer 31 controls data transmission between a first wireless network segment (hereinafter also referred to as “first wireless network”) 3 including a first access point (AP#1) 11 and a second wireless network segment (hereinafter also referred to as “second wireless network”) 4 including a second access point (AP#2) 21.

The first access point (AP#1) 11 is connected to an external network 1, such as the Internet, via a modem and a communication line. The first access point (AP#1) 11 is configured to perform wireless communications in accordance with a current or future wireless communication standard such as Institute of Electrical and Electronics Engineers (IEEE) 802.11 standard. Herein, the “IEEE 802.11 standard” represents the IEEE standard entitled “Part 11: Wireless LAN Medium Access Control (MAC) and Physical Layer (PHY) Specification,” Edition 1999, Reaffirmed Jun. 12, 2003, as well as any or all enhancement standards already ratified (e.g., IEEE 802.11a/b/g/d/h/i) and to be ratified in the future (e.g., IEEE 802.11n). Alternatively, in lieu of the IEEE 802.11 standard, other standards such as HyperLAN/x may be utilized by the invention.

The same identifier (referred to as a “Service Set Identification” or “SSID”) for identifying the wireless network segment 3 is assigned to wireless nodes that belong to the wireless network segment 3. Wireless communications are permitted only between the wireless nodes to which the same identifier is assigned.

The second access point (AP#2) 21 is connected to an internal network 2 such as a home local area network (LAN) or an office LAN. A plurality of personal computers 22 are connected to the internal network 2.

The second access point (AP#2) 21, like the first access point (AP#1) 11, is configured to perform wireless communication according to the IEEE 801.11 standard. The same identifier (SSID) for identifying the wireless network segment 4 is assigned to wireless nodes that belong to the wireless network segment 4. Wireless communications are permitted only between the wireless nodes to which the same identifier is assigned.

For illustration purposes, SSID=A is assigned to the first access point (AP#1) 11 while SSID=B is assigned to the second access point (AP#2) 21.

The personal computer 31 is located within an area to which both radio waves from the first access point (AP#1) 11 and radio waves from the second access point (AP#2) 21 can reach. The wireless LAN card 101 of the personal computer 31 is a wireless communication device that is configured to perform wireless communications according to the IEEE 801.11 standard. The wireless LAN card 101 initiates wireless communications with a wireless network segment that is an access object, using the identifier (SSID) for identifying the access-object wireless network segment.

According to one embodiment of the invention, the personal computer 31 has a function of alternately assigning to the wireless LAN card 101 an identifier of a first value (hereinafter “first identifier”) for identifying the wireless network segment 3 and an identifier of a second value (hereinafter “second identifier”) for identifying the wireless network segment 4. While the first identifier (SSID=A) is assigned to the wireless LAN card 101, the wireless LAN card 101 communicates with the first access point (AP#1) 11. On the other hand, while the second identifier (SSID=B) is assigned to the wireless LAN card 101, the wireless LAN card 101 communicates with the second access point (AP#2) 21. In this manner, the wireless LAN card 101 is wirelessly connected selectively to the first access point (AP#1) 11 or to the second access point (AP#2) in accordance with the value of the SSID that is assigned to the wireless LAN card 101.

By switching at high speed, the identifier assigned to the wireless LAN card 101 between the first identifier (SSID=A) and the second identifier (SSID=B), the wireless LAN card 101 can execute in a time-division manner the communication with the first access point (AP#1) 11 and the communication with the second access point (AP#2) 21.

Assume that a packet is transmitted from the external network 1 to a personal computer 22 on the internal network 2. The personal computer 31 receives a packet, which is sent from the first access point (AP#1) 11 and is addressed to the internal network 2, via communication between the wireless LAN card 101 and the first access point (AP#1) 11. The personal computer 31 determines the validity of the packet that is received by the wireless LAN card 101. If the packet received by the wireless LAN card 101 is valid, the personal computer 31 sends the packet to the second access point (AP#2) 21 from the wireless LAN card 101. The packet that is received by the second access point (AP#2) 21 is sent to the personal computer 22 on the internal network 2.

Thus, the personal computer 31 can function as a firewall.

FIG. 2 shows an exemplary packet transmission operation that is executed by the personal computer 31.

To start with, the personal computer 31 sets SSID=A in the wireless LAN card 101. Since the SSID of the wireless LAN card 101 coincides with the first access point (AP#1) 11, the wireless LAN card 101 and first access point (AP#1) 11 can recognize each other's presence. The wireless LAN card 101 receives a packet from the first access point (AP#) 11. The personal computer 31 determines the validity of the received packet. If the packet is valid, the personal computer 31 switches the SSID of the wireless LAN card 101 from SSID=A to SSID=B. Hence, the SSID of the wireless LAN card 101 coincides with the SSID of the second access point (AP#2). The wireless LAN card 101 and second access point (AP#2) 21 can recognize each other's presence. The personal computer 31 sends the received packet to the second access point (AP#2) 21 via the wireless LAN card 101.

Subsequently, the personal computer 31 switches the SSID of the wireless LAN card 101 from SSID=B to SSID=A. Thereby, the wireless LAN card 101 is enabled to communicate with the first access point (AP#1) 11 once again.

The wireless LAN card 101 receives a packet from the first access point (AP#) 11. The personal computer 31 determines the validity of the received packet. If the packet is valid, the personal computer 31 switches the SSID of the wireless LAN card 101 from SSID=A to SSID=B. Thereby, the wireless LAN card 101 is enabled to communicate with the second access point (AP#2) 21 once again. The personal computer 31 sends the received packet to the second access point (AP#2) 21 via the wireless LAN card 101.

In a similar manner, a packet is transmitted from the second access point (AP#2) 21 to the first access point (AP#1) 11.

In this example, the value of the SSID of the wireless LAN card 101 is switched on a packet-by-packet basis. Alternatively, the value of the SSID of the wireless LAN card 101 can be switched at predetermined time intervals.

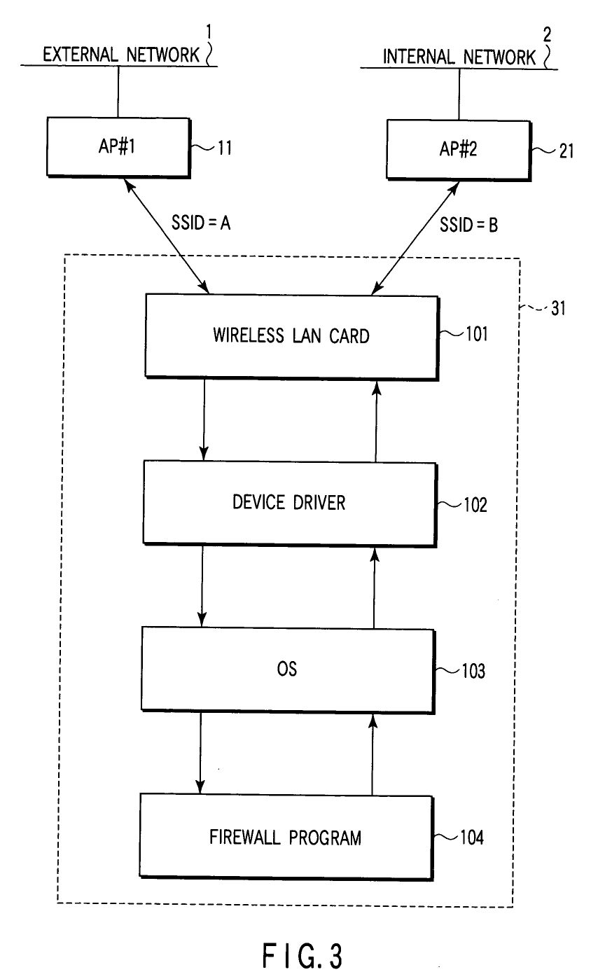

FIG. 3 shows an exemplary configuration of software modules that are provided in the personal computer 31 for the purpose of packet transmission.

A device driver 102, an operating system (OS) 103 and a firewall program 104 are installed in the personal computer 31. The device driver 102 is a program for controlling the wireless LAN card 101. The device driver 102 alternately switches the value of the SSID assigned to the wireless LAN card 101 between SSID=A and SSID=B, thereby selectively connecting the wireless LAN card 101 to one of the first access point (AP#1) 11 and second access point (AP#2) 21.

A packet from the first access point (AP#1) 11, which is received by the wireless LAN card 101, is sent to the firewall program 104 via the device driver 102 and operating system 103. The firewall program 104 has a packet filtering function that determines the validity of the received packet on the basis of address information (e.g., source address, destination address) that is included in the received packet. The firewall program 104 also has a packet filtering function that determines the validity of a received packet on the basis of a communication protocol corresponding to the received packet.

A packet, whose validity fails to be confirmed, is discarded. A packet, whose validity is confirmed, is delivered to the device driver 102 via the operating system 103. The device driver 102 transmits the packet, whose validity is confirmed, to the second access point (AP#2) 21 through the wireless LAN card 101.

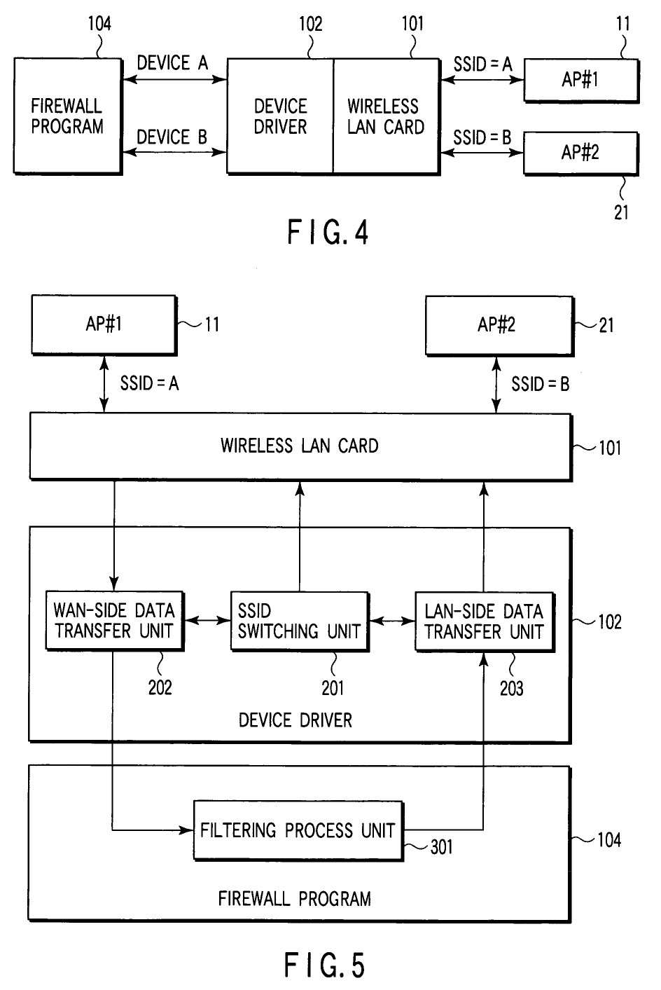

As is shown in FIG. 4, according to this embodiment of the invention, by the function of the device driver 102, the wireless LAN card 101 is recognized as following two devices from the firewall program 104 side.

1) Wireless communication device A with SSID=A assigned:

The wireless communication device A performs communication with the first access point (AP#1) 11. For example, a global IP address that is assigned to the personal computer 31 is used for communication between the wireless communication device A and first access point (AP#1) 11.

2) Wireless communication device B with SSID=B assigned:

The wireless communication device B performs communication with the second access point (AP#2) 21. For example, a local IP address that is assigned to the personal computer 31 is used for communication between the wireless communication device B and second access point (AP#2) 21.

Next, referring to FIG. 5, the functional configurations of the device driver 102 and firewall program 104 are described.

The device driver 102 includes, as functional modules, an SSID switching unit 201, a WAN-side data transfer control unit 202 and a LAN-side data transfer control unit 203. The SSID switching unit 201 executes high-speed switching of the SSID, which is used by the wireless LAN card 101, between SSID=A and SSID=B. The SSID is automatically switched, for example, at predetermined time intervals. The WAN-side data transfer control unit 202 is a module that executes data transfer with the first access point (AP#1) 11 that is the WAN-side access point. The LAN-side data transfer control unit 203 is a module that executes data transfer with the second access point (AP#2) 21 that is the LAN-side access point.

The SSID switching unit 201, WAN-side data transfer control unit 202 and LAN-side data transfer control unit 203 cooperate with each other. Specifically, when SSID=A is set in the wireless LAN card 101 by the SSID switching unit 201, the WAN-side data transfer control unit 202 operates. On the other hand, when SSID=B is set in the wireless LAN card 101 by the SSID switching unit 201, the LAN-side data transfer control unit 203 operates.

A packet from the first access point (AP#1) 11 is received by the WAN-side data transfer control unit 202. The received packet is sent to a filtering process unit 301 in the firewall program 104. The filtering process unit 301 is a module that executes the above-described packet filtering function. A packet, whose validity is confirmed, is sent from the filtering process unit 301 to the LAN-side data transfer control unit 203. Using the wireless LAN card 101, the LAN-side data transfer control unit 203 transmits the packet from the filtering process unit 301 to the second access point (AP#2) 21.

As has been described above, according to one embodiment of the invention, time-division communication can be performed with the two access points 11 and 21 using the single wireless LAN card 101. Without the need to use two network interface cards, data transmission can be realized between the two network segments.

The wireless LAN card 101 can be mounted on a system board of the personal computer 31. If the personal computer 22 has a wireless communication function, the personal computer 31 can directly perform wireless communication with the personal computer 22 without the intervention of the second access point (AP#2) 21. In this case, the SSID that is used by the wireless LAN card 101 is switched between the SSID, which is assigned to the first access point (AP#1) 11, and the SSID, which is assigned to the personal computer 22.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data transmission control apparatus controlling data transmissions between a first wireless network and a second wireless network, the data transmission control apparatus comprising:
a wireless communication device adapted to use an identifier for identifying and establishing communications with one of the first wireless network and the second wireless network; and
a device driver in communication with the wireless communication device, the device driver to alternate the identifier, used by the wireless communication device, between a first identifier for identifying the first wireless network and a second identifier for identifying the second wireless network.

2. The data transmission control apparatus according to claim 1, further comprising:
a firewall program in communication with the device driver, the firewall program to determine validity of a packet received from the first wireless network by the wireless communication device.

3. The data transmission control apparatus according to claim 1, wherein the first wireless network includes a first access point connected to a first network, and the second wireless network includes a second access point connected to a second network.

4. The data transmission control apparatus according to claim 3, wherein the first identifier, being a first Service Set Identification (SSID), is assigned to the first access point, and the second identifier, being a second Service Set Identification (SSID), is assigned to the second access point.

5. The data transmission control apparatus according to claim 4, wherein the device driver includes a first transfer unit adapted for communication with the first access point, a second transfer unit adapted for communication with the second access point, and a switching unit coupled to both the first transfer unit and the second transfer unit.

6. The data transmission control apparatus according to claim 2, wherein the firewall program to determine validity of the packet based on address information that is included in the packet.

7. The data transmission control apparatus according to claim 1, wherein the wireless communication device is a wireless local area network (WLAN) card.

8. A method for controlling data transmissions between a first wireless network and a second wireless network, the method comprising:
alternatively switching an identifier used by a wireless communication device between a first value to enable communications with the first wireless network and a second value to enable communications with the second wireless network; and
transmitting a packet received from the first wireless network to the second wireless network using the wireless communication device.

9. The method according to claim 8, wherein the transmitting includes:
determining validity of the packet that is received from the first wireless network by the wireless communication device; and
transmitting, when the validity of the packet is determined, the packet to the second wireless network using the wireless communication device.

10. The method according to claim 8, wherein the first wireless network includes a first access point of a first network, and the second wireless network includes a second access point of a second network.

11. The method according to claim 10, wherein the first value is a service set identification assigned to the first access point, and the second identifier is a service set identification assigned to the second access point.

12. The method according to claim 8, wherein the switching of the identifier includes alternately assigning the first value and the second value to the wireless communication device on a packet-by-packet basis.

13. The method according to claim 9, wherein the determining the validity of the packet includes determining the validity of the packet based on address information included in the packet.

14. The method according to claim 9, wherein the determining the validity of the packet includes determining the validity of the packet based on a communication protocol corresponding to the packet.

15. A software embodied in a storage medium for execution within an electronic device, the software comprising:
a first software module to verify validity of an incoming packet from a first wireless network; and
a second software module to alter an identifier of a wireless communication device from a first value to a second value upon verification of the validity of the incoming packet, the wireless communication device adapted for communication with the first wireless network when assigned the first value and adapted for communication with a second wireless network when assigned the second value.

16. The software according to claim 15, wherein the first software module is a firewall program to determine validity of the incoming packet based on address information within the incoming packet.

17. The software according to claim 15, wherein the first software module discards the incoming packet if validity of the incoming packet is not verified.

18. The software according to claim 15, wherein the second software module is a device driver in control of the wireless communication device and in communication with the first software module via an operating system of the electronic device.

19. The software according to claim 15, wherein the second software module causes the wireless communication device to alternate between (i) the first value, being a service set identification of a first access point of the first wireless network, and (ii) the second value, being a service set identification of a second access point of the second wireless network.

20. The software according to claim 19, wherein the second software module automatically alternating between the first value and the second value at predetermined time intervals.
